(19) United States
(12) Patent Application Publication
(10) Pub. No.: US 2024/0001721 A1
(43) Pub. Date: Jan. 4, 2024

(54) METHOD FOR MONITORING OPERATING PARAMETERS OF THE TIRES OF AN AIRCRAFT

(71) Applicant: SAFRAN LANDING SYSTEMS, Velizy-Villacoublay (FR)

(72) Inventors: Philippe CHICO, Moissy Cramayel (FR); Joël ZABULON, Moissy Cramayel (FR)

(73) Assignee: SAFRAN LANDING SYSTEMS, Velizy-Villacoublay (FR)

(21) Appl. No.: 18/038,596

(22) PCT Filed: Nov. 23, 2021
(86) PCT No.: PCT/FR2021/052073

§ 371 Date: May 24, 2023

(30) Foreign Application Priority Data
Nov. 25, 2020 (FR) 2012119

(51) Int. Cl. B60C 23/04

(52) U.S. Cl. CPC B60C 23/0479; B60C 23/0471; B60C 2200/02

(57) ABSTRACT

A method of monitoring aircraft tire operating parameters includes pairing of transmission modules with wheel positions of an aircraft to obtain a cartography associating emission modules with wheel positions, storing the obtained cartography, transmitting data including information identifying the emission module, and operating parameter values of tire operating parameters measured by a sensor, checking an existence of an association between the information identifying the emission module and a wheel position on a given aircraft in the cartography to ensure that the information received belongs to the given aircraft, and displaying the operating parameter values and the wheel on which the one operating parameter values have been measured.

### GENERAL TECHNICAL FIELD

The invention relates to the field of predictive monitoring and maintenance of aircraft components, also called “health monitoring.” It relates more precisely to a method for pairing components of a system for verifying operating parameters of aircraft tires.

### PRIOR ART

From the cockpit or during maintenance operations, it is useful to know certain operating parameters of the tires of the different wheels of the landing gear of an aircraft; the tire pressure can be mentioned for example, but also the temperature of the gas contained in the tires.

To this end, it is known to utilize measurement sensors of an aircraft of this type directly installed on the wheel (for example tire pressure sensors, sensors of the temperature of the gas contained in the tires, etc.). These sensors, often grouped into a single component known under the designation TPMS (for “Tire Pressure Monitoring System”), coupled with an on-board data processing system, allow the pilots to have a display in the cockpit of the state of the pressure of each of the tires during the different phases of flight. During maintenance operations, the operators, moving within the cockpit, can also consult this display in order to obtain the desired information.

Each TPMS mounted on a rim of the wheel is supplied with power and communicates by means of electrical wires which pass through the axle and along the landing gear.

On certain airplanes one (or more) electrical junction box groups the wires of each wheel, and at least one strand of wires ascends along the landing gear toward the rest of the airplane. These electrical cablings and connecting boxes are heavy and expensive.

One known alternative for reducing the mass and the cost consists of replacing the wired link with a wireless communication between each TPMS and one or more receiving modules installed in the airplane, for example in the landing gear wells or in the fuselage. However, though this wireless communication certainly brings mass gains, it also brings new problems compared to a wired link. In fact, in the case of a wired link it is very simple to identify which wheel the measurements come from, it is sufficient in fact to associate an entry channel with a wheel. However, when a wireless communication system is used, in particular when it is integrated into a wheel cover as is often the case, there is no means allowing identifying from which wheel the measurements received originate, or even whether the measurements received do not originate from the wheels of a nearby aircraft.

### PRESENTATION OF THE INVENTION

One goal of the invention is to propose a more robust system for monitoring the operating parameters of the tires of an aircraft.

To this end, the invention proposes, according to a first aspect, a method for monitoring operating parameters of aircraft tires, by means of a verification system, said method comprising the following steps implemented by an operator terminal, said operator terminal comprising a wireless receiving module suitable for receiving operating parameters transmitted by a wireless transmitting module associated with each of the wheels of an aircraft, said wireless transmitting module being connected by a communication link to at least one sensor, and being configured to transmit operating parameters measured by said at least one sensor via a wireless communication link, said receiving module comprising a display device configured to display these different measurements of tire operating parameters to an operator of the aircraft, the method comprising the following steps implemented in a data processing unit of said operator terminal:
E1) pairing the wireless transmitting modules to wheel positions of the aircraft so as to obtain, for a given aircraft, a mapping associating the wireless transmitting modules with wheel positions on the aircraft;
E2) storing the mapping thus obtained in a database;
E3) transmitting, by means of a transmitting module to the wireless receiving module, data comprising information identifying the wireless transmitting module, as well as at least one value of a tire operating parameter measured by a sensor positioned on a tire connected to the wireless transmitting module;
E4) verifying of the existence of an association between the information identifying the wireless transmitting module and a wheel position on a given aircraft in the mapping database so as to ensure that the information received belongs to the given aircraft;
E5) displaying the at least one operating parameter comprised in the data received by the wireless receiving module as well as the wheel on which this at least one operating parameter value has been measured.

Certain preferred but not limiting features of the method according to the first aspect are the following, taken individually or in combination:
step E1 comprises the sub-steps of:
   selecting a wheel position on the aircraft;
   entering information identifying a transmitting module,
      these steps being repeated for each wheel position on the aircraft, in order to accomplish a mapping of the transmitting modules present on the wheels of the aircraft;
the pairing is accomplished by means of a portable terminal, then the mapping database is transferred from the portable terminal to an on-board computer of the aircraft;
the information identifying a transmitting module is a serial number and/or a reference number and/or a barcode;
the information identifying a transmitting module is stored in a radio tag;
the wireless communication link used for transmitting the operating parameters measured by the at least one sensor is a link of one type among the following: Bluetooth, Zigbee, Wi-Fi, Li-Fi, radio,
the wireless transmitting module is housed in a wheel cover of the aircraft, the information identifying the wireless transmitting module is a serial number and/or a reference number which uniquely identifies the wireless transmitting module and which is written on the wheel cover.

According to a second aspect, the invention proposes a device for monitoring the operating parameters of the tires of an aircraft, comprising:
a wireless transmitting module associated with each of the wheels of an aircraft, said wireless transmitting module being connected by a communication link to at least one sensor, and being configured to transmit the operating parameters measured by said at least one sensor via a wireless communication link;
an operator terminal, said operator terminal comprising a wireless receiving module suitable for receiving operating parameters transmitted by the transmitting module, said receiving module comprising a display device configured to display these different tire operating parameters to an operator of the aircraft;
suitable data storage means comprising a database;
data processing means suitable for implementing the steps of:
E1) pairing the wireless transmitting modules with wheel positions of the aircraft so as to obtain, for a given aircraft, a mapping associating the wireless transmitting modules with wheel positions on the aircraft;
E2) storing the mapping thus obtained in the database;
E3) transmitting of data comprising information identifying the wireless transmitting module, as well as at least one value of a tire operating parameter measured by a sensor positioned on a tire connected to the wireless transmitting module, by means of a transmitting module to the wireless receiving module;
E4) verifying the existence of an association between the information identifying the wireless transmitting module and a wheel position on a given aircraft in the mapping database so as to ensure that the information received belongs to the given aircraft;
E5) displaying the at least one operating parameter value comprised in the data received by the wireless receiving module as well as the wheel on which this at least one operating parameter value has been measured.

Certain preferred but not limiting features of the device according to the second aspect are the following, taken individually or in combination:
the wireless transmitting module is housed in wheel covers of the aircraft;
the wireless transmitting module is housed in the sensor to which it is connected,
the wireless transmitting module is housed in a wheel cover of the aircraft, the information identifying the wireless transmitting module is a serial number and/or a reference number which uniquely identifies the wireless transmitting module and which is written on the wheel cover.

### PRESENTATION OF THE FIGURES

Other features and advantages of the present invention will appear upon reading the description which follows of a preferred embodiment. This description will be given with reference to the appended drawings in which:

FIG. 1 is a schematic view of an aircraft equipped with a monitoring system for implementing a monitoring method according to the invention;

FIG. 2 shows in perspective the terminal portion of a landing gear comprising two wheels, each integrating a portion of the monitoring system for implementing a monitoring method according to the invention;

FIG. 3 shows the steps of a monitoring method according to the invention.

### DETAILED DESCRIPTION

Monitoring System

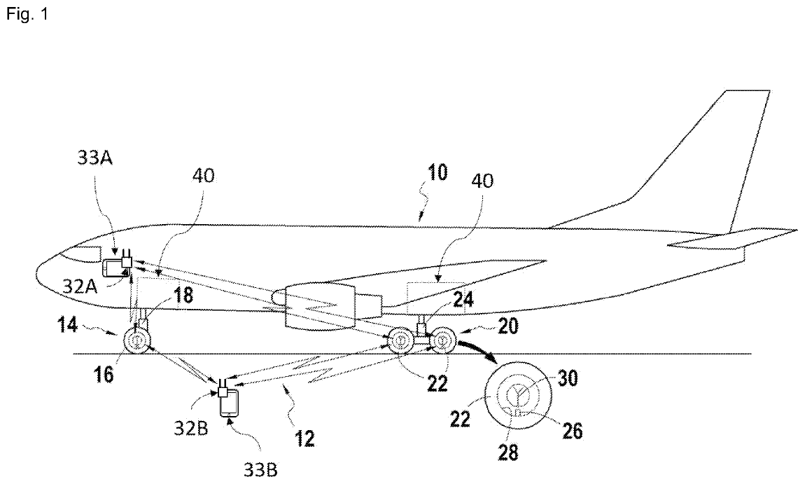

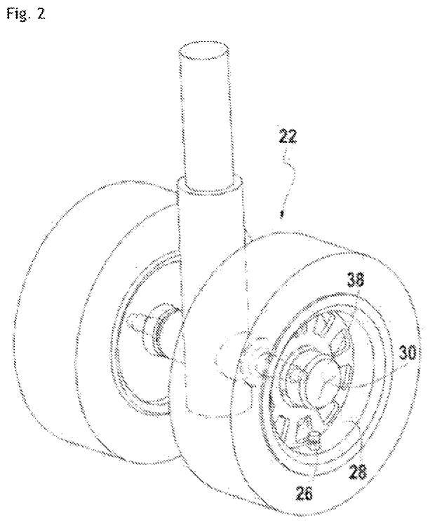

With reference to FIGS. 1 and 2, a system for the implementation of a method for monitoring the operating parameters of the tires 22 of an aircraft 10 comprises a set of wheels on which are mounted the tires, these wheels being grouped into landing gear, generally a first landing gear located at the front of the aircraft and two others located substantially in the center of the machine, on either side of a longitudinal axis of the aircraft. These landing gear sets are each associated with a well 40 into which the landing gear can retract during flight phases.

To each tire equipping a wheel of the aircraft corresponds at least one sensor 26 (for example a pressure sensor), carried by the rim 28 of the wheel, and a wireless transmitting device 30 which can be integrated into the cover 38 of the wheel, or directly integrated into the sensor 26 (which allows simplifying the device), by means of which the operating parameters of the tire measured by the sensor(s) are transferred to an operator terminal 33A, 33B comprising a wireless receiving module 32A, 32B. This operator terminal also comprises a display device allowing displaying the operating parameters of the tires measured on each of the wheels. This user terminal can be implemented in the form of a portable terminal, for example a touch-screen tablet, a computer dedicated to maintenance, or any other specialized equipment having means allowing the display of information relating to the operating parameters of the tires as well as of the wheel of the aircraft on which these parameters have been measured, but this operator terminal can also be integrated into the cockpit of the aircraft and connected to the on-board computer. The use of a portable terminal is particularly advantageous within the scope of the maintenance operations.

In one preferred embodiment, when a portable terminal is used as the operator terminal, the wireless receiving module is integrated directly into the portable terminal, simplifying its use and allowing monitoring the operating parameters of an aircraft even when its electrical systems are shut down. In one alternative embodiment, when the operator terminal is integrated into the cockpit of the aircraft, the receiving module is dissociated from the display device and can be comprised in the fuselage of the aircraft, typically at a position maximizing the reception quality of the signals originating from the different transmitting modules; it is also possible to provide for several receiving modules located at different places, for example in the landing gear wells, for the same reason of maximizing the reception quality, these receiving modules can then be connected to the other elements of the operator terminal by a wired connection or also by a wireless connection.

The operator terminal is also associated with data processing means of the processor type which can be the processor of the portable terminal or a processor of the on-board computer of the aircraft, data storage means of the computer memory type which can be the memory of the portable terminal or a memory of the on-board computer of the aircraft, as well as a data entry interface (or user interface) allowing a user to interact with the data recorded by the data storage means, it too being able to be integrated with the portable terminal or associated with the display device integrated into the cockpit and connected to the on-board computer. The storage means can, in one variant embodiment, be distant storage means in the form of a server, thus allowing to keep a history of the mapping database, as well as to use the same mapping database on several portable terminals without requiring systematic pairing.

The processing and storage means and the interface thus allow management of data relating to the wireless transmitting modules present on the wheels of the aircraft; these data, called a “mapping database,” comprise in particular associations between a wheel position of the aircraft (traditionally these positions are numbered, the numbering method depending on the type of aircraft) and a unique identifier associated with the transmitting module present on this wheel. Thus, when a transmitting module transmits data on the operating parameters of the tire to which it is associated, these data can be received, then processed by the processing means in order to identify from which wheel of the aircraft the data received originate (or even whether these data actually originate from a particular aircraft and not from another located nearby when these are parked on the ground).

Monitoring Method

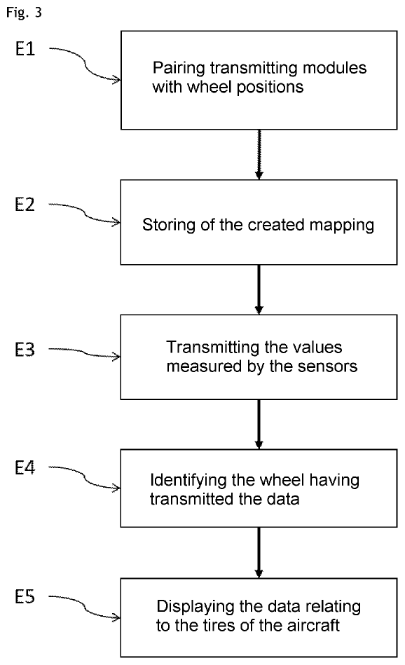

With reference to FIG. 3, the monitoring method implemented by the system previously described comprises the following steps. A first step E1, called a pairing step, during which an operator of the aircraft, for example a maintenance operator or a pilot, takes note of the unique identifiers associated with each transmitting module present on the wheels of the aircraft. According to one embodiment, the wireless transmitting module 30 is housed in a wheel cover 38 of the aircraft, the information identifying the wireless transmitting module is a serial number and/or a reference number which uniquely identifies the wireless transmitting module 30 and which is written on the wheel cover 38. These identifiers can be a serial number and/or a reference number uniquely identifying the transmitter, written on the transmitter or, when it is integrated in a wheel cover, written on the wheel cover. To take note of the unique identifiers associated with each transmitting module present on the wheels of the aircraft, the operator can then select a wheel position of the aircraft and enter, via the data entry interface, the serial and/or reference numbers; in an alternative embodiment it is also possible to associate a barcode (1D or 2D) with each transmitter; it is then sufficient for the operator to “flash” said barcode by using a specialised device or simply a photo camera (for example that integrated into a touch-screen tablet), largely simplifying the data entry operation.

Similarly, a radio tag (or RFID tag) can be used, which then allows accomplishing the data entry operation simply by bringing a suitable reader nearby (a suitable reader being able for example to be integrated into the portable terminal), this embodiment has the advantage of not being sensitive to wear or to fouling as numbers or a barcode written on a wheel cover could be. The mapping database associating a wheel position on the aircraft with a unique identifier of a transmitter is then recorded by means of storage means during a step E2.

When the data entry operation is accomplished by means of a portable terminal, it is also possible to transfer the mapping database produced from the portable terminal to the on-board computer of the aircraft by preferably using a wired data link between the portable terminal and the on-board computer. This operating mode thus allows recording a mapping database of the associations between a wheel and a transmitting module in the storage means of the on-board computer without necessitating a new data entry by the operator, and therefore allows simplifying the data entry operation. It is, however, also possible to manually take note of the identifiers of the transmitting modules and then to record them by means of a data entry interface in the cockpit of the aircraft.

This pairing step is generally accomplished a first time when the final assembly of the aircraft is accomplished, then during maintenance operations, in particular when the wheels of the aircraft are replaced. In fact, the replacement of the wheels often brings about incorrect replacement of the wheel covers and therefore, when the transmitting modules are integrated into the wheel covers, errors of association between a wheel position and a transmitting module. The regular implementation of the pairing method thus allows ensuring good monitoring of the tires of the aircraft.

Following the pairing step, the monitoring system is then able to identify and display information relating to the operating parameters of the tires of the aircraft; the following steps of the monitoring method can then be implemented.

In a step E3, a wireless transmitting module transmits data comprising the values measured by the sensors to which it is connected via a wireless data link, this link being able to rely for example on the Bluetooth standard (formerly the IEEE 802.15.1 standard), on the IEEE 802.15.4 standard (Zigbee for example), protocols in the IEEE 802.11 family (Wi-Fi), Li-Fi, radio, etc.

The transmitted data can also comprise information identifying the transmitting module, for example its serial and/or reference number, or a network address (in this case, it is this network address which must be recorded during the association between a transmitting module and a wheel position on the aircraft).

It will be obvious that this transmitting step can be accomplished by several transmitting modules at the same moment, present on the wheels of the aircraft to be monitored, but also when it is parked on the ground, by wheels of nearby aircraft equipped with a similar device. Moreover, it can be repeated at regular intervals in order to ensure continuous tracking of the operating parameters of the tires.

Following reception, by a wireless receiving module of the aircraft being monitored, of data comprising information identifying a transmitting module as well as values measured by the sensors connected to this transmitting module, the wireless receiving module will transmit the data received to processing means (for example, those of the portable terminal or those of the on-board computer).

In a step E4, identification of the source of the transmitted data received by the receiving module. This identification being accomplished by comparing the identification information of the transmitting module received to the mapping database stored in the storage means. When information associating a network address to a transmitting module is available, it is also possible to accomplish filtering at the receiving module in order to receive and transfer only data relating to the tires mounted on the monitored aircraft. In an alternative embodiment, this identification can be accomplished upstream of the data reception by using a session mode operation in which a connection between a transmitting module and a receiving module of the aircraft to be monitored is previously accomplished.

Finally, in a step E5, all the information identified as actually originating from the wheels of the monitored aircraft is displayed by means of a display device in order to make this information available to the operators of the aircraft. The different measurements transmitted can for example be displayed on a schematic view of the aircraft, at a position representing the wheel of the aircraft from which the displayed measurement(s) originate(s), it is also possible to accompany these measurements with a value or nominal range of values of these measurements indicating proper operation (for example the nominal pressure value of the tires), thus allowing the operators of the aircraft to schedule any necessary maintenance task.

1. A method for monitoring at least one operating parameters of tires of wheels of an aircraft, by means of a verification system, an operator terminal comprising a wireless receiver suitable for receiving the at least one operating parameters transmitted by a wireless transmitter associated with each of the wheels of the aircraft, the wireless transmitter being connected by a first communication link to at least one sensor and being configured to transmit the at least one operating parameters measured by the at least one sensor via a second wireless communication link, the wireless receiver comprising a display device configured to display the at least one operating parameter of the tires having been measured to the operator terminal, the method comprising the following steps implemented in a data processor of the operator terminal:
E1) pairing the wireless transmitters to wheel positions of the aircraft so as to obtain, for the aircraft, a mapping associating the wireless transmitters with the wheel positions on the aircraft;
E2) storing the mapping thus obtained in a database;
E3) transmitting for each wireless transmitter, by means of the wireless transmitter to the wireless receiver, data comprising information identifying the wireless transmitter, as well as at least one value of the at least one operating parameter of the tire, having been measured by the at least one sensor positioned on the tire and connected to the wireless transmitter;
E4) verifying, for each wireless transmitter, of an existence of the mapping associating the information identifying the wireless transmitter and one of the wheel positions on the aircraft in the database so as to ensure that the information received belongs to the aircraft;
E5) displaying the at least one operating parameter comprised in the data received by the wireless receiver as well as the wheel on which the value of the at least one operating parameter has been measured.

2. The method according to claim 1, wherein the step E1 comprises the following sub-steps:
selecting one of the wheel positions on the aircraft;
entering the information identifying the wireless transmitter,
the sub-steps being repeated for each wheel position on the aircraft in order to accomplish the mapping of the wireless transmitters present on the wheels of the aircraft.

3. The method according to claim 2, wherein the pairing is accomplished by means of a portable terminal, the database having the mapping stored therein then being transferred from the portable terminal to an on-board computer of the aircraft.

4. The method according to claim 1, wherein the information identifying the wireless transmitter is a serial number and/or a reference number and/or a barcode.

5. The method according to claim 1, wherein the information identifying the wireless transmitter is stored in a radio tag.

6. The method according to claim 1, wherein the second wireless communication link used to transmit the at least one operating parameter measured by the at least one sensor is a link of a type among the following: Bluetooth, Zigbee, Wi-Fi, Li-Fi, radio.

7. The method according to claim 1, wherein for each of the wireless transmitters associated to each of the wheels of the aircraft, the wireless transmitter is housed in a wheel cover of the wheel of the aircraft, the information identifying the wireless transmitter is a serial number and/or a reference number which uniquely identifies the wireless transmitter and which is written on the wheel cover of the wheel of the aircraft.

8. A device for monitoring at least one operating parameter of tires of wheels an aircraft, comprising:
a wireless transmitter associated with each of the wheels of the aircraft, the wireless transmitter being connected by a first communication link to at least one sensor and being configured to transmit the at least one operating parameter measured by the at least one sensor via a second wireless communication link;
an operator terminal, the operator terminal comprising a wireless receiver suitable for receiving the at least one operating parameter transmitted by the wireless transmitters, the wireless receiver comprising a display device configured to display the at least one operating parameter of the tires having been measured to the operator terminal;
a storage memory comprising a database;
a processor for implementing the following steps:
E1) pairing the wireless transmitters with wheel positions of the aircraft so as to obtain, for the aircraft, a mapping associating the wireless transmitters with the wheel positions on the aircraft;
E2) storage in the database of the mapping thus obtained;
E3) transmission, for each wireless transmitter, of data comprising information identifying the wireless transmitter, as well as at least one value of the at least one operating parameter measured by the at least one sensor positioned on the tire and connected to the wireless transmitter, by the wireless transmitter to the wireless receiving receiver;
E4) verification, for each wireless transmitter, of an existence of the mapping associating the information identifying the wireless transmitter and one of the wheel positions on the aircraft in the database so as to ensure that the information received belongs to the aircraft;
E5) displaying of the at least one value of the at least one operating parameter comprised in the data received by the wireless receiver as well as of the wheel on which the value of the at least one operating parameter has been measured.

9. The device according to claim 8, wherein for each of the wireless transmitters associated to each of the wheels of the aircraft, the wireless transmitter is housed in a wheel cover of the wheel of the aircraft.

10. The device according to claim 8, wherein for each of the wireless transmitters associated to each of the wheels of the aircraft, the transmitter is housed in the at least one sensor to which the wireless transmitter is connected.

11. The device according to claim 8, wherein for each of the wireless transmitters associated to each of the wheels of the aircraft, the wireless transmitter is housed in a wheel cover of the wheel of the aircraft, the information identifying the wireless transmitter is a serial number and/or a reference number which uniquely identifies the wireless transmitter and which is written on the wheel cover.
